(19) United States
(12) Patent Application Publication
(10) Pub. No.: US 2018/0240068 A1
(43) Pub. Date: Aug. 23, 2018

(54) REMIX CAPACITY MANAGEMENT FOR OPTICAL ORDERS

(71) Applicant: Essilor International, Charenton-le-Pont (FR)

(72) Inventors: Michael A. FILIPOVICH, Dallas, TX (US); Michael HELTEMES, DALLAS, TX (US)

(21) Appl. No.: 15/752,865

(22) PCT Filed: Aug. 14, 2015
(86) PCT No.: PCT/IB2015/001552

§ 371 Date: Feb. 14, 2018

(51) Int. Cl. G06Q 10/08; G06Q 30/06

(52) U.S. Cl. CPC G06Q 10/08355; G06Q 10/0875; G06Q 30/0635; G06Q 30/0641

(57) ABSTRACT

The disclosed embodiments include systems, computer-implemented methods, and computer-readable storage media that execute, are configured to, or store instructions that enables the routing and remixing optical lens orders. In one embodiment, the optical lens orders are received at a central routing system that is separate from any optical lens production facility or center. In other embodiments, the routing system may be incorporated or be located at one or more optical lens production center. The routing system is configured to determine an optical lens production center for routing the optical lens order based on attributes of the optical lens orders and based on a set of remixing or proportional rules.

### BACKGROUND

The present disclosure relates generally to systems, computer-implemented methods, and computer-readable storage media that execute, are configured to, or store instructions that enables the routing and remixing optical lens orders.

Optical lens production centers need to manage the number and mix of optical lens orders that flow through a given routing hub and to manage the number and mix of orders in production. For instance, every optical lens production center has a limit on the number of orders it can produce in a day and a limit on the number of orders it can handle for any given process (e.g. blocking, surfacing, coating and specific coatings or processes). Often times there are just a few production centers that can perform a specific process and it's challenging for administrators to manage the appropriate mix of orders to these sites without overwhelming one process or work flow. For example, on days where there are more orders than usual or days when a device breaks down, the labs often have to work overtime to keep up with the workload and orders can become late for delivery.

Today, managers must plan for overtime or manually route orders to another facility if there are too many orders in the shop for a given process. This process is difficult to gauge and difficult to manage as production hubs continue to grow in size and breadth of services, and as optical lens orders continue to become more diverse and complex.

To address the above problems, the disclosed systems and methods of the present application provide labs and administrators an effective tool to manage the distribution of orders that are sent through routing hubs so that a more controlled distribution of orders can be maintained relative to capacity and capability at the production centers. The disclosed embodiments will also give the production centers the capability to automatically route orders to a different production center when the incoming count on a given day reaches a configured limit. The routed orders can be controlled in their flow to the next production centers to allow proportioned or fixed mix of work among destinations.

Advantages of the disclosed embodiments include better capacity management, work flow, on-time delivery, and less overtime. The disclosed embodiments enable more specialization in production centers and even more complex flows than current process.

### BRIEF SUMMARY OF THE DISCLOSED EMBODIMENTS

The disclosed embodiments include systems, computer-implemented methods, and computer-readable storage media that execute, are configured to, or store instructions that enables the routing and remixing optical lens orders. In one embodiment, the optical lens orders are received at a central routing system that is separate from any optical lens production facility or center. In other embodiments, the routing system may be incorporated or be located at one or more optical lens production center. The routing system is configured to determine an optical lens production center for routing an optical lens order based on the attributes of the optical lens order and based a set of remixing or proportional rules.

As one example, specific embodiments disclosed herein include a system that is configured to routing and remixing optical lens orders. In one embodiment, the system includes memory for storing computer executable instructions and data; and a processor for executing the computer executable instructions. For instance, in one embodiment, the computer executable instructions comprise instructions for, in no particular order, receiving an optical lens order; determining a plurality of attributes associated with the optical lens order; determining a plurality of optical lens production centers capable of fulfilling the lens order; retrieving a set of proportionality rules associated with the plurality of optical lens production centers; retrieving attribute data associated with lens orders for each of the plurality of optical lens production centers; determining an optical lens production center to route the optical lens order based on the attribute data associated with lens order for each of the plurality of optical lens centers and the set of proportionality rules associated with the plurality of optical lens production centers; and routing the optical lens order to the determined optical lens production center; and incrementing a count for each attribute of the plurality of attributes associated with the optical lens order in the attribute data corresponding to the determined optical lens production center.

Other aspects and advantages of the invention will be apparent from the following description and the appended claims.

### BRIEF DESCRIPTION OF THE DRAWINGS

Illustrative embodiments of the present invention are described in detail below with reference to the attached drawing figures, which are incorporated by reference herein, and wherein:

FIG. 1 illustrates a system and network configuration for routing and remixing optical lens orders in accordance with one embodiment;

FIG. 2 illustrates a second network configuration for routing and remixing optical lens orders in accordance with one embodiment;

FIG. 3 is a flowchart illustrating a process for routing and remixing optical lens orders in accordance with one embodiment;

FIG. 4 illustrates three records for assigning a record to a material group control in accordance with one embodiment;

FIG. 5 illustrates an example of an order and its group control assignments in accordance with one embodiment;

FIG. 6 illustrates an example of instructions for creating a group name set in accordance with one embodiment;

FIG. 7 illustrates examples of group name sets that can be created by combining group controls in accordance with one embodiment;

FIG. 8 illustrates routing rules that may be used for making order routing decisions in accordance with one embodiment; and

FIG. 9 illustrates a record for remixing job orders based on proportionality and minimum and maximum requirements in accordance with one embodiment.

The illustrated figures are only exemplary and are not intended to assert or imply any limitation with regard to the environment, architecture, design, or process in which different embodiments may be implemented.

### DETAILED DESCRIPTION

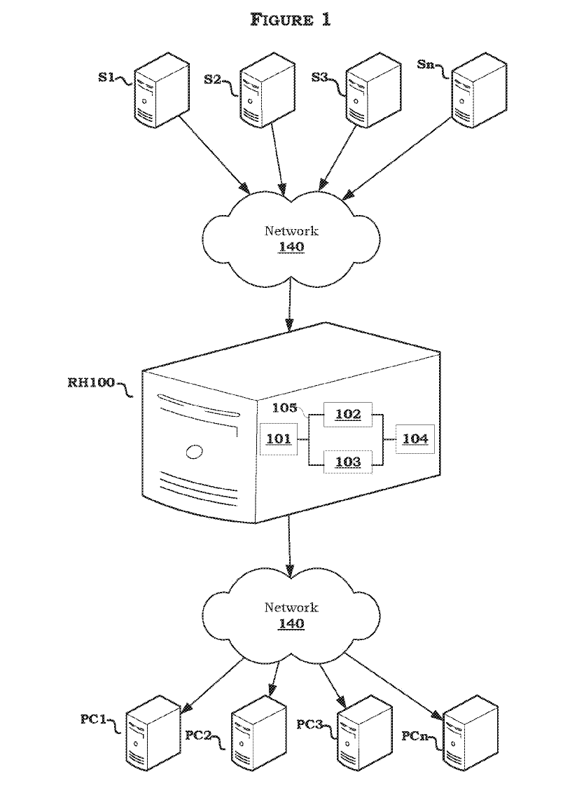

FIG. 1 illustrates a system and network configuration for routing and remixing optical lens orders in accordance with one embodiment. In the depicted embodiment, a routing hub system 100 is used to distribute work in proper proportion to production centers. For example, in accordance with one embodiment, the routing hub system 100 may be configured to achieve the routing or distribution of a minimum number of optical lens orders to a particular production site before routing optical lens orders to another production site to achieve cost efficiency. In certain embodiments, the routing hub system 100 may also be configured to proportionally spread optical lens orders among production centers based on staffing levels. For example, production center 1 might have personnel that can take on 20% of the orders, production center 2 might be staffed for 40% of the orders, and production center 3 might take on the remaining 40% of the orders.

In some instances, production center 2 might also be a specialty hub and specific order types must go there and cannot go to production center 1 or production center 3. Thus, in accordance with the disclosed embodiments, the number of specific specialty orders must be factored into the 20-40-40 mix or it could overwhelm a production center if a lot of specialty orders come in.

In addition, in certain embodiments, the routing hub system 100 is configured to provide production centers with capacity management capabilities since their incoming orders might not all arrive through a single routing hub that controls the incoming flow. For example, large retailers often offer 2 for 1 sales or 50% off sales that can cause an overwhelming flow of orders to a production center. These orders might flow directly to one or two production centers and cause an overload in production. Thus, in accordance with the disclosed embodiments, the routing hub system 100 can be configured to recognize large inflows and automatically distribute the overload to predetermined destinations with a logical mix.

In addition, the disclosed embodiments provide administrators with the capabilities to configure gateway hubs, subsidiaries and laboratories to distribute a wide and complex array of orders among destination sites based on attributes of the order and prioritized remix groups and rules. These rules can be configured to work in priority order and in relation to other rules to achieve balance of the flow among sites. For example, as will be further described, one or more of the disclosed embodiments include the following capabilities:

1) Ability to count an order toward multiple remix rules even though one or even none has been used to route the order to another location.

2) Ability to count all orders that come into the system and not just orders that have routed out.

3) Ability to decide routing based on minimum number of orders of a given remix rule to a given site.

4) Ability to decide routing based on maximum number of orders of a given remix rule to a given site.

5) Ability to proportionally distribute orders among multiple sites by percentage with respect to both minimum numbers and/or maximum numbers allowed at any given site.

6) Ability to include specialty or higher priority rules in proportioning orders for more general rules. For example, Crizal® (CZL) coating might be more specialized and route to a single destination. It's also a more general anti-reflective coating and should be considered as part of the proportioning among anti-reflective rules that are more generalized since other aspects of the coating process (e.g. cleaning) have limits that are affected by all types of coated lenses (not just CZL).

Additionally, the disclosed embodiments may be configured to improve consumer direct purchasing in which orders are shipped directly from a production site to a patient's home. For example, one or more of the disclosed embodiments include a feature for routing optical lens orders that takes into account a ‘supply frame’ condition to help guide the order to a production site that stocks the frame. Without this feature, production sites might need to ship orders from one site to another (or frame from one site to another) in order to fulfil the complete order if the order is routed to a site that doesn't stock the chosen frame. Alternatively, the business must stock more frames at more sites which is less cost effective. This feature will optimize flow of orders to sites that stock the needed frame to reduce turn-around time and keep costs down when fulfilling a consumer-direct order.

Referring back to FIG. 1, in one embodiment, the routing hub system 100 comprises a plurality of components including one or more processors 101, a computer-readable storage media 102, an input/output interface 103, and a network interface 104. Each of the components of the routing hub system 100 communicates via a system bus 105 that connects and transfers data between the various components. The processors 101 are configured to process data and execute computer-executable instructions. These instructions may include, but are not limited to, machine code instructions, bytecode for a software interpreter, object code, and source code in a high-level programming language.

Data and computer-executable instructions are stored in the computer-readable storage media 102. The computer-readable storage media 102 may be any appropriate memory device or computer storage media, such as, but not limited to, a hard disk drive, random access memory, read only memory, electrically erasable programmable read-only memory, flash memory or other memory technology, compact disc—read only memory, digital versatile disks or other optical disk storage, magnetic cassettes, magnetic tape, magnetic disk storage or other magnetic storage devices. In some embodiments, the data and executable instructions may be stored on a component or device that is external to the routing hub system 100 (e.g., on the cloud, an external memory drive, or an external database).

The input/output (I/O) interface 103 comprises an input interface for receiving user input or data from one or more peripheral devices. For example, the I/O interface 103 may receive user input or data from one or more input devices such as, but not limited to, a keyboard, mouse, touch screen, microphone, scanner, and/or a camera. The I/O interface 103 also comprises an output interface for outputting information to one or more device or component associated with the routing hub system 100. For example, the I/O interface 103 may output data or other information to a display device for displaying information to a user, another system, and/or to a printer.

The network interface 104 is not limited to any particular communication protocol or hardware interface. For example, the network interface 104 may include one or more wired or wireless interfaces such as, for example, an Ethernet port or a wireless transceiver for enabling the routing hub system 100 to send and receive data over one or more networks such as, but not limited to, network 140.

The network 140 may be any type of wired or wireless network, which may include one or more public or private networks or some combination thereof, such as the Internet, an intranet, a mobile cellular or data network, or any other network operable to transmit data to and from the routing hub system 100 to other devices in communication with the network 140.

As depicted in FIG. 1, in one embodiment, the routing hub system 100 is configured to receive optical lens orders from a mix of optical stores (S₁ to Sₙ) such as, but not limited to, Walmart®, Costco®, Target®, LensCrafters®, Pearle Vision®, online retailers, and Optician offices. In accordance with the disclosed embodiments, the routing hub system 100 is configured to route optical lens orders to one of a plurality of production centers (PC₁ to PCₙ). As will be further described, the routing hub system 100 may be configured to allow a higher level of routing control that is dedicated to the capacities of the production centers. For example, in one embodiment, the routing hub system 100 may be configured to distribute orders proportionately among production centers based on combinations of routing conditions, site groups, proportioning rules and more. For instance, the routing hub system 100 may be configured to allow an administrator to group production sites into logical groups. As an example, three production centers might be capable of coating, but only one of those three production centers might be capable of edging. In one embodiment, the three coating production centers can be combined into one group and the edging/coating production center can also be combined with other edging sites. Thus, any one site can be a group of its own and also be part of other site groups.

Still, in some embodiments, the routing hub system 100 may be configured to allow an administrator at a production center to adjust percentages and/or minimums and maximums to achieve the best mix of orders with far greater predictability and control than any other system in production today. For example, in accordance with one embodiment, assume that orders are split 20% to production center 1, 30% to production center 2, and 50% to production center 3 based on the capacity of each site, and that all three production centers can do anti-reflective coating, but only production center 2 is equipped to produce a new CZL coating. Now assume that on a given day that 500 optical lens orders come through the routing hub system 100 which distributes the orders to these three production centers. Of the 500 incoming orders, 120 of them are orders with CZL coating. Under this scenario, the routing hub system 100 may be configured to send 100 orders to production center 1, but none of them CZL, send 150 orders of the 500 to production center 2 that includes all 120 of the CZL optical lens orders, and send the remaining optical lens orders to production center 3.

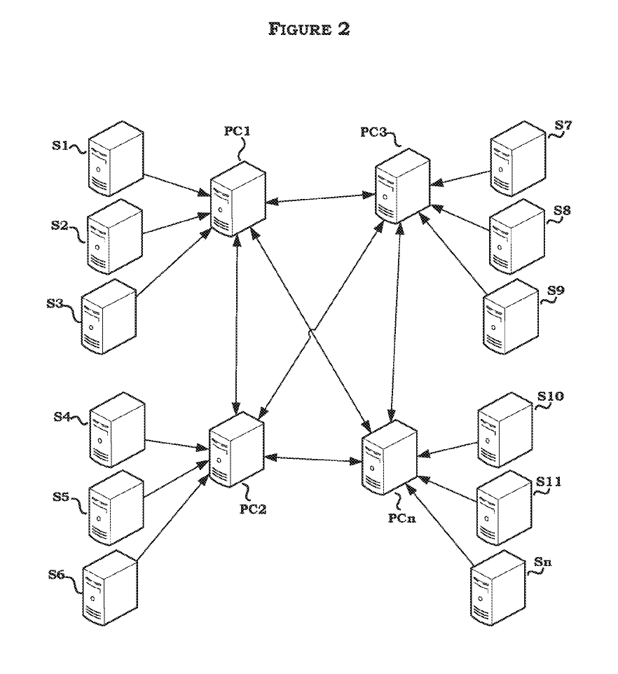

FIG. 2 illustrates an alternative embodiment in which the optical stores (S₁ to Sₙ) send their orders directly to a one of a network of production centers (PC₁ to PCₙ) instead of through a centralized routing hub. For example, as depicted in FIG. 2, in one embodiment, a production center (PC1) is configured to receive optical lens orders from a particular group of optical retail stores (S1-S3). In this topology, the systems at the production centers are configured in accordance with the disclosed embodiments to manage the mix of orders that it keeps internally and the mix of orders it chooses to route to another production center. In turn, the other production centers also use the innovation to manage the mix of orders it keeps internally or forwards on to another center in the lab network or even to an off-shore production center.

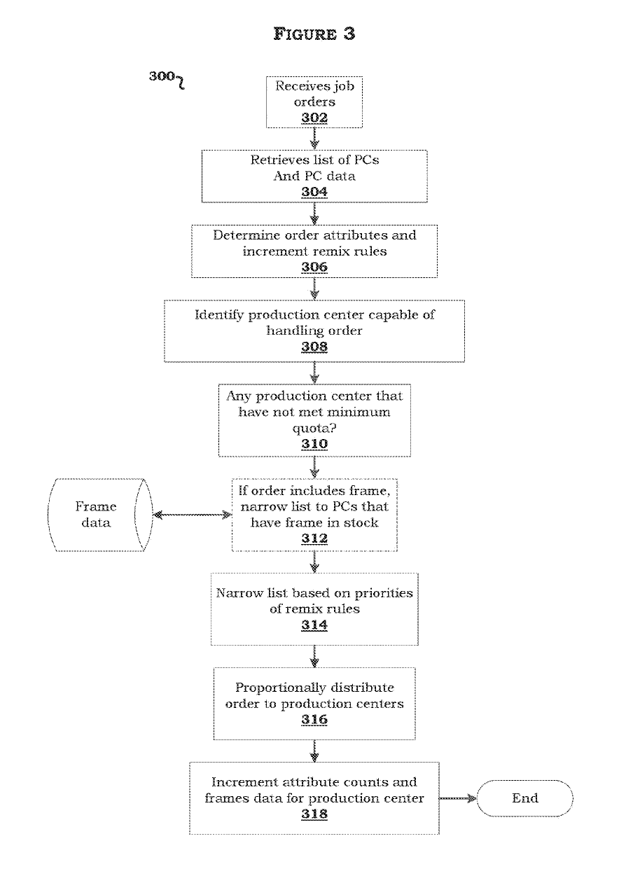

FIG. 3 is a flowchart illustrating a process 300, executed by a routing system, such as, but not limited to, routing hub system 100, for routing and remixing optical lens orders in accordance with one embodiment. The process begins with the routing hub system 100 receiving optical lens orders at step 302. As previously described, the orders may be received from a number of optical stores such as retailers that provide optical services, online optical retailers, and eye care practitioner offices. In addition, in certain embodiments, an order may be received from an optical production center that is not capable of handling the order itself for any number of reasons such as being understaffed, a machine malfunction, overcapacity of orders, or there is a particular requirement of the order that the production center is unable to perform.

At step 304, the process queries a database to retrieve a list of optical production centers that are available to process the received order(s). The process also retrieves the corresponding processing data associated with each of the production centers such as, but not limited to, processing capabilities, current inventory, current level of production, and current orders with specialty attributes.

At step 306, the process increments a counter for all remix rules that apply to attributes of a received order. For instance, in one embodiment, the process first assesses attributes of the order to capture attributes of the order that are applicable to the routing process. For example, the received order may have one or more of the following attributes: anti-scratch, anti-smudge, anti-dust, hydrophobic, UV-blocking, edged, mineral, Crizal® coating, and a polycarbonate material. In one embodiment, the process fetches data from a series of data tables that list meaningful attributes and commits a “group control” name to memory when the order matches the rules that are kept in the data tables. In one embodiment, these tables allow group controls of, but not limited to, account, frame, Rx, Light-ups, Style, Lens Material, and Lens Color.

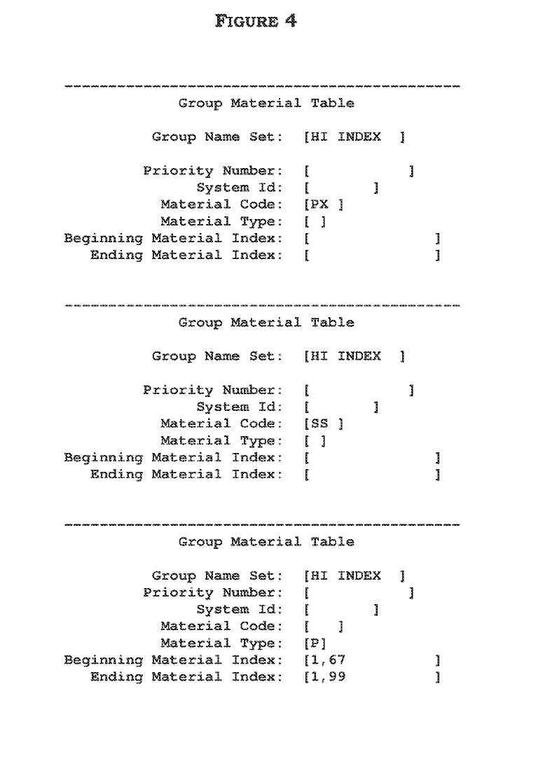

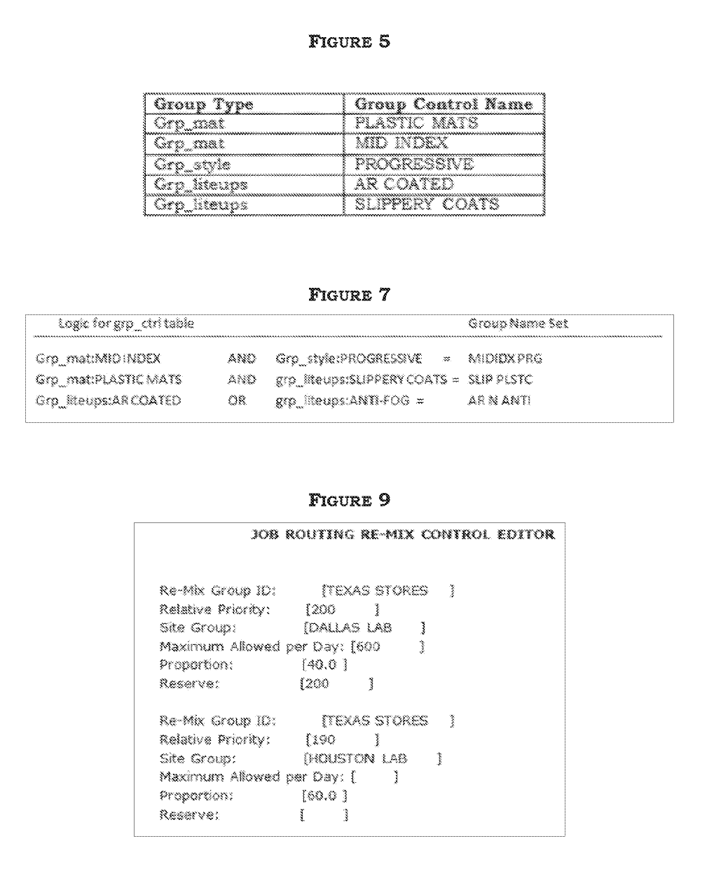

For example, FIG. 4 illustrates a table that allows a series of records to assign a material group control. For instance, FIG. 4 illustrates three records for a material group control titled HI INDEX. Using the data tables illustrated in FIG. 4, the process will logically determine whether the material code is one of PX, SS, or P (Plastic) with index of refraction between 1.67 and 1.99, and if so, the process assigns the attribute of group material control of HI INDEX for this order. This same process would be performed through all the records for other attribute groups such as, but not limited to, group style and group color. In some embodiments, there can be more than one control for each type of record or table. For example, a Crizal® Prevencia™ coating could qualify as AR COATED, SLIPPERY COAT, and PREMIUM COAT in the group Light-ups control if an administrator applied Crizal® Prevencia™ light-up to multiple control records with different control names. The process will increment a count for orders for each of these attributes when applying the individual remix rules. An example of an order and its group control assignments is illustrated in FIG. 5.

In some embodiments, group controls can be combined in various ways to create “group name sets”. The group name sets are then used in the routing rule decisions. In one embodiment, the logic for the group name sets is similar to that for the group controls, and is expanded to include AND/OR logic. For example, FIG. 6 illustrates an example of instructions for creating a group name set. In the depicted example, a group name set of MIDIDX PROG is created in memory for an order if the order has the following group control attributes: grp_{'}mat control of MID INDEX and the grp_style control of PROGRESSIVE. As shown in FIG. 6, other group control attributes can be combined or used in the MIDIDX PROG group name set such as, but not limited to, fr_groups, branch, name set, grp_acct, grp_frame, grp_mat, grp_rx, grp_style, grp_liteups, grp_color, etc.

FIG. 7 illustrates examples of other group name sets that can be created by combining group controls. In one embodiment, these group name sets can then be combined either together or individually with or without additional conditions in a routing manager table for making order routing decisions as will be further described below.

For instance, referring back to FIG. 3, at step 308, the process identifies production centers that are capable of handling the received order based on the order's attributes and based on the processing data associated with each of the production centers. For example, in one embodiment, the process eliminates all production centers that are at maximum capacity for any single attribute associated with order (e.g., Crizal® coating, anti-reflective (AR) coating, edged, and glass/mineral). In some embodiments, the process will also eliminate any production center that has notified the routing hub system of any work stoppage for certain attributes. For example, a production center may provide notification to the routing hub system that it's edging machine is currently down for maintenance.

At step 310, from the list of available production centers capable of handling the received order, the process determines if any of the production centers have a minimum quota for orders that have not been met. If so, the list of available production centers are narrowed down to those production centers having minimum quotas for orders that have not been met. Otherwise, the list of available production centers capable of handling the received order is maintained as is.

In one embodiment, the process can determine if the received order includes frames, and if so, the process may be configured at step 312 to narrow the list of available production centers capable of handling the received order to those that have the ordered frame in stock. For example, in one embodiment, the process may query a database that contains the frame inventory for each of the production centers. For example, in one embodiment, the database includes a table that can be populated with the frame UPC/FPC codes for frames that can be expected to be stocked at the different destination sites. Based on this information, the process is able to identify production centers that have the requested frame in stock at its location. This feature will enable the customer to be able to receive the complete order in the shortest amount of time.

At step 314, the process is configured to narrow the list of available production centers capable of handling the received order based on priorities of remix rules. For example, in accordance with the disclosed embodiments, the system may be configured to route orders among production centers based on location (e.g., distance from a customer or within a certain territory), time of day, day of week, and/or based on special capabilities such as, but not limited to, AR coating and digital processing capabilities that might not be available at all production centers in the routing landscape.

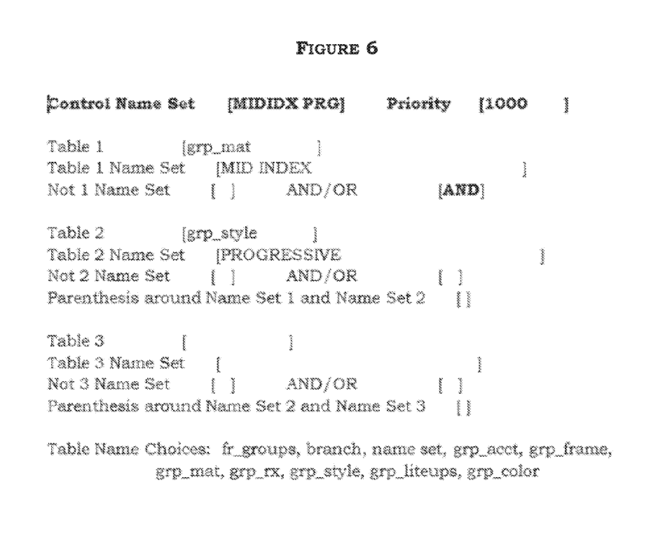

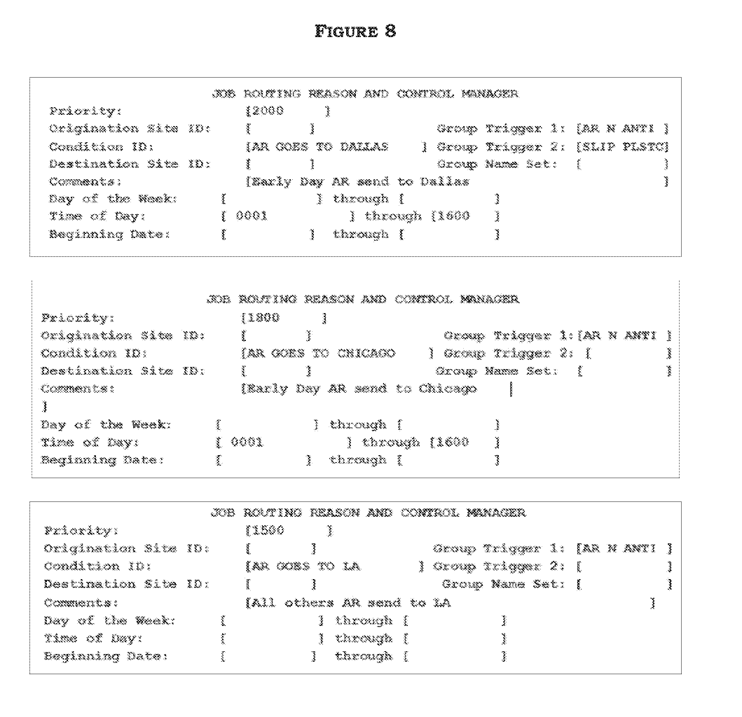

For instance, as described above, the group name sets can be combined either together or individually with or without additional conditions in a routing manager table for making order routing decisions. As an example, FIG. 8 illustrates three routing rules in the routing manager table that may be used for making order routing decisions. In the given example, both Dallas and LA production centers are capable of processing AR coated or Anti-fog orders, but Dallas stops production at 4:00PM and LA can take orders later in the day because they're on the west coast. However, in accordance with the first routing rule, because Dallas is especially equipped for slippery coatings, any order that's AR coated or Anti-fog, and also has the constraint of having a slippery coating will be routed to Dallas. If the order does not have slippery coating constraint and is received before 4:00PM, then in accordance with the second routing rule, the order is routed to Chicago. The third rule may be the default rule to send the order to LA if neither the first or second rule applies to the order. In one embodiment, the process will process the rules from highest priority first toward lowest priority and stops as soon as it finds an acceptable reason to route.

In accordance with the disclosed embodiments, at step 316, the process may also be configured to proportionally distribute or remix the orders to production centers. For example, as described above, the process may distribute 20% of orders to production center 1, 30% to production center 2, and 50% to production center 3 based on the capacity and capabilities of each production center including taking in to account any minimum and/or maximum quota associated with a production center. For instance, all orders that have attributes that can only be handled by a particular production center are distributed to the particular production center and counted against its proportional distribution.

As an example, the process can create a record assigning DALLAS to a site group named TEXAS SITES. The TEXAS SITES group might be used to route orders among labs in Texas to keep shipping costs down by keeping the orders in a localized area. The site groups can then be used to prioritize routing among groups of sites and to manage maximum volume to any one group, or to proportion work among multiple groups by the percentage of work that's routed in a given day. Rules can also establish a maximum number of orders be delivered to a given group before attempting to distribute according to proportion rules.

For example, FIG. 9 illustrates a record for remixing job orders based on proportionality, and minimum and maximum orders. In the given example, the Dallas production center has a maximum of 600 orders per day that it can process. Dallas also requires a minimum of 200 orders per day to make the Dallas lab cost-effective to run, so the process will reserve the first 200 orders that come in to go to this lab before considering the proportioning rules. However, after the first 200 jobs have routed to the Dallas lab, the process will begin proportioning the orders according to the 40% allocated to Dallas and the 60% allocated to Houston. The process will evaluate the number of orders that have been routed among the sites and respect the proportions configured as it routes each order. In accordance with the proportioning rule, once the maximum of 600 orders has been routed to Dallas, the proportions won't apply any longer and all remaining orders are routed Houston. In one embodiment, priority may be assigned to a given record. For example, as indicated in the first record for the Dallas lab, the Dallas record has a higher priority than the record for the Houston lab. The higher priority record will be processed by the system first when it goes through the routing process.

Referring back to FIG. 3, at step 318, the process increments the attribute counts and frames data for the production center that the received order is routed. For example, if the order includes Crizal® coating, the attribute count for both Crizal® coating and AR coating for the production center is incremented to indicate that the production center has an order that includes Crizal® coating and an order that includes AR coating because Crizal® coating is a specialized type of AR coating. In other words, the process will increment the count for a specialized attribute (e.g., CZL) as well as a general attribute (AR coating) that encompasses the specialized attribute. By incrementing the count for each attribute of an order, the process provides a finer grain solution that can further control the routing decision. For example, a given destination site might have limits to how many edged or AR coated jobs that it can do in a day. If the process only incremented the edged orders and did not count this order as both an edged order and also as a AR coated order, then the process would not be able to effectively limit the number of AR coated jobs it sends to the given destination.

Additionally, if the order included frames, the frames data in the frames database is updated to indicate that the frame is no longer available or there is one less frame of that type in inventory at the production center. By taking all the effective rules into account, the process can be set up to manage the different layers of routing rules each on its own merits. The counts toward each rule will be all-inclusive and appropriate minimums, maximums and proportions can be managed effectively.

The process ends and is repeated for any new optical lens order that the system receives.

Accordingly, the disclosed systems and methods of the present application provide labs and administrators an effective tool to manage the distribution of orders that are sent through routing hubs, so that a more controlled distribution of orders can be maintained relative to capacity and capability at the production centers.

The above disclosed embodiments add a far superior level of control and effectiveness over the existing capabilities. For example, advantages of the disclosed embodiments include, but are not limited to, the following:

It has a broad array of controls that allow the lab or subsidiary to allow the system to decide when and where to route an order.

It can route or dispatch thousands of orders each hour to support large networks and production systems.

It allows administrators to fine tune the minimums, maximums, and proportions easily without rethinking the entire logical flow of the routing rules. This reduces risk and provides more predictable results.

It can limit the overload that often occurs at production sites whether it's to the sites overall capacity or capacity of that site to produce a specific process.

It can help lab networks achieve a steady flow of work to its production centers to allow them a consistent number of orders daily that allows for predictable staffing levels with less need for overtime or times when there's not enough work to do.

It can direct specific order types to centers that need a minimum volume to achieve profitability and insure that these sites get first priority for these specific order types.

It can balance the number of orders that go off-shore and help insure the appropriate mix of orders for on-shore vs off-shore production.

It reduces the complexity of the administration process by allowing administrators to adjust the proportions of well-established remix rules rather than adjusting attributes in a complex set of rules in attempts to hit the right number of orders to route.

It includes the capability to count orders of a given type that have arrived at a production center without being routed out.

It allows quick and predictable reaction by administrators of a given site or process is compromised. For example, if there's a flood at a large production hub, an administrator can quickly adjust the proportions among sites to reduce that site to 0 and spread its proportion appropriately among other operational sites. Similarly, if a site is mostly functional, but its coating center loses electricity, the administrator can adjust the number of coated orders to go to other sites without changing the logic of the rules until electricity is restored while uncoated orders can continue to flow in and through production.

It keeps track of counts within subsets and supersets of remix rules which allows the administrator to configure counts and proportions for subsets at higher priority and to configure counts and numbers of supersets at lower priority which allows tight control of limited or specialty processes while also counting jobs routed using those subset (specialty) rules in the rules for supersets. By counting the same order in both sets of rules, the administrator won't need to manage the added complexity of discrete rule sets which are problematic today in complex sets of routing rules where this innovation is not yet available.

This innovation has special logic to support the “supply frame” condition which will allow greater control and ability to manage consumer-direct orders with abilities to use specialized controls that favor routing of a “supply frame” order to a site that would stock that frame in inventory.

The above disclosed embodiments has been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/blocks may be performed in parallel or out of sequence, or combined into a single step/block. The scope of the claims is intended to broadly cover the disclosed embodiments and any such modification.

As used herein, the singular forms “a”, “an” and “the” are intended to include the plural forms as well, unless the context clearly indicates otherwise. It will be further understood that the terms “include”, “including”, “comprise”, and/or “comprising,” when used in this specification and/or the claims, specify the presence of stated features, steps, operations, elements, and/or components, but do not preclude the presence or addition of one or more other features, steps, operations, elements, components, and/or groups thereof In addition, the steps and components described in the above embodiments and figures are merely illustrative and do not imply that any particular step or component is a requirement of a claimed embodiment.

Additionally, although specific terms are employed herein, they are used in a generic and descriptive sense only and not for purposes of limitation. For instance, the term database, as used herein, is intended to include any form of organized data, including, but not limited to, data found in tables, charts, spreadsheets, and documents. Furthermore, the term database does not imply the use of a particular or specialized database software nor does it imply the use of any particular data structure.

1. A system configured to route optical lens orders, the system comprising:
memory for storing computer executable instructions and data; and
a processor for executing the computer executable instructions, wherein the computer executable instructions comprises instructions for:
receiving an optical lens order;
determining a plurality of attributes associated with the optical lens order;
determining a plurality of optical lens production centers capable of fulfilling the lens order;
retrieving a set of proportionality rules associated with the plurality of optical lens production centers;
retrieving attribute data associated with lens orders for each of the plurality of optical lens production centers;
determining an optical lens production center to route the optical lens order based on the attribute data associated with lens order for each of the plurality of optical lens centers and the set of proportionality rules associated with the plurality of optical lens production centers;
routing the optical lens order to the determined optical lens production center; and
incrementing a count for each attribute of the plurality of attributes associated with the optical lens order in the attribute data corresponding to the determined optical lens production center.

2. The system of claim 1, wherein the plurality of attributes associated with the optical lens order includes one or more of following coatings: anti-scratch, anti-smudge, anti-dust, hydrophobic, UV-blocking, edged, and mineral.

3. The system of claim 1, wherein the set of proportionality rules associated with the plurality of optical lens production centers includes a daily maximum number of optical lens orders.

4. The system of claim 3, wherein the daily maximum number of optical lens orders is associated with a particular attribute associated with the lens order.

5. The system of claim 1, wherein the set of proportionality rules associated with the plurality of optical lens production centers includes a daily minimum number of optical lens orders.

6. The system of claim 5, wherein the daily minimum number of optical lens orders is associated with a particular attribute associated with the lens order.

7. The system of claim 1, wherein the set of proportionality rules associated with the plurality of optical lens production centers includes distributing optical lens orders among the plurality of optical lens production centers by percentage with respect to both a minimum number of optical lens orders and a maximum number of optical lens orders assigned to each of the optical lens production centers.

8. The system of claim 1, wherein the set of proportionality rules associated with the plurality of optical lens production centers includes assigning a priority to a particular attribute associated with the lens order.

9. The system of claim 1, wherein incrementing the count for each attribute of the plurality of attributes associated with the optical lens order in the attribute data corresponding to the determined optical lens production center includes incrementing the count for a specialized attribute as well as a general attribute that encompasses the specialized attribute.

10. The system of claim 1, wherein determining the plurality of attributes associated with the optical lens order includes determining whether the optical lens order includes frames, and wherein retrieving attribute data associated with lens orders for each of the plurality of optical lens production centers includes retrieving frame supply data for each of the plurality of optical lens production centers in response to a determination that the optical lens order includes frames.

11. The system of claim 10, wherein the set of proportionality rules associated with the plurality of optical lens production centers includes matching the frames associated with the optical lens order to an optical lens production center having the frame in inventory.

12. A computer-implemented method for routing optical lens orders, the method comprising:
receiving an optical lens order;
determining a plurality of attributes associated with the optical lens order;
determining a plurality of optical lens production centers having capabilities to fulfill the lens order;
retrieving a set of proportionality rules associated with the plurality of optical lens production centers;
retrieving attribute data associated with lens orders for each of the plurality of optical lens production centers;
determining an optical lens production center to route the optical lens order based on the attribute data associated with lens order for each of the plurality of optical lens centers and the set of proportionality rules associated with the plurality of optical lens production centers; and
routing the optical lens order to the determined optical lens production center.

13. The computer-implemented method of claim 12, further comprising incrementing a count for each attribute of the plurality of attributes associated with the optical lens order in the attribute data corresponding to the determined optical lens production center.

14. The computer-implemented method of claim 12, wherein the set of proportionality rules associated with the plurality of optical lens production centers includes a daily maximum number of optical lens orders and a daily minimum number of optical lens orders.

15. A computer-readable storage media having stored thereon computer-executable instructions, that when executed by a processor of a system, performs the steps of:
receiving an optical lens order;
determining a plurality of attributes associated with the optical lens order;
determining a plurality of optical lens production centers having capabilities to fulfill the lens order;
retrieving a set of proportionality rules associated with the plurality of optical lens production centers;
retrieving attribute data associated with lens orders for each of the plurality of optical lens production centers;
determining an optical lens production center to route the optical lens order based on the attribute data associated with lens order for each of the plurality of optical lens centers and the set of proportionality rules associated with the plurality of optical lens production centers;
routing the optical lens order to the determined optical lens production center; and
incrementing a count for each attribute of the plurality of attributes associated with the optical lens order in the attribute data corresponding to the determined optical lens production center.

16. The computer-implemented method of claim 14, wherein the daily maximum number of optical lens orders is associated with a particular attribute associated with the lens order.

17. The computer-implemented method of claim 14, wherein the daily minimum number of optical lens orders is associated with a particular attribute associated with the lens order.

18. The computer-implemented method of claim 12, wherein the set of proportionality rules associated with the plurality of optical lens production centers includes distributing optical lens orders among the plurality of optical lens production centers by percentage with respect to both a minimum number of optical lens orders and a maximum number of optical lens orders assigned to each of the optical lens production centers.

19. The computer-implemented method of claim 12, wherein determining the plurality of attributes associated with the optical lens order comprises determining whether the optical lens order includes frames.

20. The computer-implemented method of claim 12, wherein retrieving attribute data associated with lens orders for each of the plurality of optical lens production centers comprises retrieving frame supply data for each of the plurality of optical lens production centers in response to a determination that the optical lens order includes frames.
